(19) United States
(12) Patent Application Publication
(10) Pub. No.: US 2026/0042424 A1
(43) Pub. Date: Feb. 12, 2026

(54) WIPER BLADE WITH MICROSTRUCTURES

(71) Applicant: Hoowaki, LLC, Greenville, SC (US)

(72) Inventors: Ralph Hulseman, Greenville, SC (US); Carl Hulseman, Westminster, CO (US); Braden Vaughan, Greenville, SC (US); David Farrow, Anderson, SC (US)

(73) Assignee: Hoowaki, LLC, Greenville, SC (US)

(21) Appl. No.: 19/295,218

(22) Filed: Aug. 8, 2025

Related U.S. Application Data
(60) Provisional application No. 63/681,218, filed on Aug. 9, 2024.

(51) Int. Cl. B60S 1/38

(52) U.S. Cl. CPC B60S 1/38; B60S 2001/3817; B60S 2001/3837

(57) ABSTRACT

The present disclosure provides a wiper blade for cleaning a vehicle surface comprising an elongated, rubber-elastic wiper strip provided with respective longitudinal grooves on corresponding opposite long sides for securing to a mounting structure and with a wiper surface with an array of longitudinal microfeatures for contact with a surface wherein each microfeature is substantially rectangular in cross-section, an elongated spring-elastic mounting structure having corresponding slots and rails to engage the longitudinal grooves of the wiper strip, and a connection device for a wiper arm or handle connected to the middle portion of the mounting structure. The microfeatures replace a single wiping edge with multiple wiping edges to reduce noise, improve durability, and enable simplification of the wiper blade design. The wiper surface may have two sides that alternately contact the surface or a single side that maintains continuous contact during wiping motion in both directions.

### RELATED APPLICATION

This application claims priority in U.S. Provisional Patent Application 63/681,218 filed Aug. 9, 2024 which is incorporated buy reference.

### BACKGROUND OF THE INVENTION

### 1) Field of the Invention

This invention relates to a wiper blade for cleaning surfaces, such as windows of motor vehicles, and specifically to a wiper blade comprising a rubber elastic wiper strip with microstructures on a portion of its surface.

### 2) Description of the Related Art

In wiper blades of the prior art attempts have been made to achieve the most uniform cleaning of the wiped field over the longest number of use cycles possible. One approach to achieve this is to assure the most uniform distribution of the wiper blade contact pressure on the window over the entire field swept by the wiper blade. Some attempts include a wind deflector strip added to the wiper strip to improve uniformity of distribution of the wiper blade contact pressure on the window. However, this structure applies pressure to the blade and is not an improvement of the blade itself.

Another approach to achieve the most uniform cleaning of the wiped field is to add multiple blades on a single wiper arm or to add multiple wiper strips onto a single wiper blade. For example, some structures include a pair of wiper parts joined to a wiper strip which is then attached to a support mechanism. However, this simply adds strips without improvement to the blade. For example, a pair of wiper parts joined to a wiper strip can be attached to a support mechanism. Some attempts include adding additional parts to the blade such as a triangular scrubbing component that is molded in the wiper strip or adhesively bonded to the wiper strip and designed to assist in debris removal.

None of these approaches has proven satisfactory and further improvements are needed.

Wipers need frequent replacement, such as yearly at least, and thus are one of the first items needing maintenance, including wipes for vehicles such as electric vehicles. Wipers are often noisy while in operation, which is more obtrusive in quiet electric vehicles and not desirable. Wiper arm motors also consume electrical power thereby reducing vehicle range, since the wipes include friction of the wiper blades on the surface to be wiped such as windows. It is desirable to further improve wiping performance, length durability, reduce noise emission and reduce friction and power consumption.

Under the current state of the art, the extrusion process (which includes drawing), generally produces a surface with a smooth or fine finish. It would be advantageous to be able to impart surface properties onto extrusion material during the extrusion process which results in the parts resulting from the extrusion process having certain physical properties. U.S. Pat. No. 9,120,670 B2 and U.S. Pat. No. 9,908,274 B2 describe methods for imparting microfeatures on parts during the extrusion process.

Microfeatures placed on a part can provide for advantageous surface properties. By including a plurality of microfeatures on the surface of an object, other characteristics may be imparted to the object, such as increased hydrophobicity, hydrophilicity, self-cleaning ability, hydrodynamics drag coefficients, aerodynamic drag coefficients, frictional properties, and optical effects.

Historically, microfeatures were applied to surfaces as coating, adhesive or chemical reaction and therefore are prone to wear of the surface. Over time the properties provided by the microstructures are lost. Further, the applications of a coating or adhesive would have to be added to the extrusion process and would not naturally be integrated into the extrusion process. Further coatings, adhesives and chemical reactions add cost.

A particular challenge in applying microstructures to wiper blades arises from the manufacturing processes typically employed in wiper blade production. Conventional wiper blade manufacturing relies heavily on extrusion processes to form the rubber-elastic wiper strips. During extrusion, the rubber material is forced through a die to create the desired cross-sectional profile of the wiper strip. However, traditional extrusion dies are designed to produce smooth surfaces and uniform cross-sections, making it difficult to incorporate microstructures directly into the extruded product. The high pressures and flow characteristics inherent in the extrusion process may cause incomplete filling of microstructure cavities in the die, leading to poorly formed or inconsistent microfeatures. Additionally, the material flow dynamics during extrusion may result in bridging across small cavities intended to form microstructures, preventing proper formation of the desired surface features. The thermal conditions required for proper rubber curing during extrusion may also affect the dimensional stability and definition of small-scale microstructures. These manufacturing limitations have historically made it challenging to produce wiper blades with integrated microstructures using conventional extrusion techniques, necessitating alternative approaches or significant modifications to existing manufacturing processes.

It is desirable to further improve uniformity of distribution of the wiper blade contact pressure on the window and to reduce cost and complexity of the wiper blade support structure.

Therefore, it is an object of this invention to further improve wiping performance, lengthen durability, improve uniformity of distribution of the wiper blade contact pressure, reduce noise emission and reduce friction and power consumption.

### SUMMARY OF THE INVENTION

The objects above are achieved by the addition of a micro surface with many micro features, each with wiping edges, on the wiping strip wiping tip to provide a multitude of wiping edges to replace the single wiping edge engaged as a wiper blade moves in one direction across an automotive windshield. The wiping strip wiping tip may be elongated and made more flexible to bring more micro features in contact during each wiping pass. Use of a micro surface with a multitude of edges allows the wiping tip that flips from one side to the other, as the wiper arm changes direction, to be replaced by a flattened, single sided, wiper tip that maintains continuous contact with the window as the wiper arm changes direction. The flattened, single sided, wiper tip can incorporate a resilient rubber beam to simplify or eliminate the need for a plastic or metal support structure.

The invention provides a lower contact pressure per wiping edge which reduces the stress and strain on each edge which in turn reduces the rate of abrasion, wear and cutting which lengthens durability. The lower contact pressure per wiping edge, and the cross-section shape and stiffness of the micro features reduces the static friction relative to the dynamic friction, lowers overall friction and shifts the resonant frequency of the wiper strip to eliminate stick-slip behavior and reduce noise. Lower overall friction reduces power consumption. The multitude of wiping edges improves wiping performance, analogous to how multiple blade razors produce improve a closer shave without cuts. The multitude of wiping edges cuts through water films repeatedly in a single pass which along with better uniformity of distribution of the wiper blade contact pressure, produces better wiping. Since the pressure per wiping edge in reduces, the overall pressure of the wiper arm on the blade may be increased to reduce wind driven lift at high vehicle speeds.

The invention is a wiper blade for cleaning vehicle, window, and structural glass having microstructures comprising an elongated, rubber-elastic wiper strip provided with respective longitudinal grooves on corresponding opposite long sides for securing to a mounting structure and with a wiper surface with an array of longitudinal micro ribs for contact with a window wherein each micro rib is substantially rectangular in cross-section; an elongated spring-elastic mounting structure having corresponding slots and rails to engage the longitudinal grooves of the wiper strip; and a connection device for a wiper arm or handle connected to the middle portion of the mounting structure.

In a further embodiment of the invention, the wiper surface has two sides that alternately contact the window as the wiping motion occurs in one direction and then the reverse direction and on each side of the wiper surface the number of longitudinal micro ribs in the array is between 2 and 75; the height of the longitudinal micro ribs is between 20 microns and 1,000 microns; and the width of the longitudinal micro ribs is between 20 microns and 1,000 microns. The array of micro ribs is designed such that sliding noise on a dry or damp window is reduced below 50 dB in the standard test.

In a further embodiment of the invention, the wiper blade has a single side that contacts the window as the wiping motion occurs in one direction and then the reverse direction; the single side that contacts the window may have a cross-section surface shape contacting the glass that is flat, convex, concave in shape, or any of these with have rounded, beveled inward or beveled outward edges; on the single side of the wiper surface the number of longitudinal micro ribs in the array is between 2 and 150; the height of the longitudinal micro ribs is between 20 microns and 1,000 microns; and the width of the longitudinal micro ribs is between 20 microns and 1,000 microns. The array of micro ribs on the single contact surface are designed such the flop noise is reduced below 50 dB as the wiping motion changes from one direction to the reverse direction; and the array of micro ribs is designed such that sliding noise on a dry or damp window is reduced below 50 dB in the standard test.

In another embodiment of the invention, a wiper blade for cleaning vehicle, window, and structural glass having microstructures comprises an elongated, rubber-elastic wiper strip provided with an integrated mounting structure and with a wiper surface with a multitude of longitudinal micro ribs for contact with a window wherein each micro rib is substantially rectangular in cross-section; an integrated spring-elastic mounting structure consisting of a rubber and textile shear beam made with at least one layer of an inelastic textile; and a connection device for a wiper arm or handle connected to the middle portion of the integrated mounting structure. The wiper surface has two sides that alternately contact the window as the wiping motion occurs in one direction and then the reverse direction; on each side of the wiper surface the number of longitudinal micro ribs is between 2 and 75; the height of the longitudinal micro ribs is between 20 microns and 1,000 microns; and the width of the longitudinal micro ribs is between 20 microns and 1,000 microns. The array of micro ribs is designed such that sliding noise on a dry or damp window is reduced below 50 dB in the standard test.

In another embodiment of the invention, the wiper blade with an integrated mounting structure has a wiper surface with a single side that contacts the window as the wiping motion occurs in one direction and then the reverse direction; the single side that contacts the window may have a cross-section surface shape contacting the glass that is flat, convex, concave, or any of these with rounded, beveled inward or beveled outward edges; on the single side of the wiper surface the number of longitudinal micro ribs is between 2 and 150; the height of the longitudinal micro ribs is between 20 microns and 1,000 microns; and the width of the longitudinal micro ribs is between 20 microns and 1,000 microns. The array of micro ribs and the single contact surface are designed such the flop noise is reduced below 50 dB as the wiping motion changes from one direction to the reverse direction; and the array of micro ribs is designed such that sliding noise on a dry or damp window is reduced below 50 dB in the standard test.

The wiper strip microstructures can include physical characteristics selected from the group consisting of: hydrophobicity, hydrophilicity, self-cleaning, decreased or increased hydro-dynamic drag coefficients, decreased or increased aerodynamic drag coefficients, increased friction, reduced friction, optical effects, increased adhesion, decreased adhesion, oleophobicity, oleophilicity, tactile effects, anti-blocking and any combination of these.

The microstructures can be selected from the group consisting of two-dimensional cross-sections: continuous ribs, discontinuous ribs, ribs with a cross-section that is rectangular, square, triangular, rounded hump, jagged, overhang or T-shaped. The microstructures can be selected from the group consisting of three-dimensional features: pillars, voids, steps, ridges, curved regions, recessed regions, columns, cross-section shapes comprising circles, ellipses, triangles, squares, rectangles, polygons, stars, hexagons, letters, numbers, symbols, and any combination of these.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a side view of the wiper blade assembly;

FIG. 2 Cross-section profile of wiper strip;

FIG. 3 Cross-section profile of support structure and wiper strip;

FIG. 4 Micro surface terminology;

FIG. 5A Array of square cross-section pillars;

FIG. 5B Array of oval cross-section pillars, FIG. 5C Array of continuous ribs;

FIG. 6 is a schematic cross-section of aspects of the invention;

FIG. 7 is a schematic cross-section of aspects of the invention;

FIG. 8 is a schematic cross-section of aspects of the invention;

FIG. 9A is a schematic cross-section of aspects of the invention showing a wide flat wiping tip;

9B narrow is a schematic cross-section of aspects of the invention showing a narrow flat wiping tip;

FIG. 10A is a schematic cross-section of aspects of the invention showing profile edges angled out;

FIG. 10B is a schematic cross-section of aspects of the invention showing profile edges angled in;

FIG. 11 is a schematic cross-section of aspects of the invention;

FIG. 12 is a schematic cross-section of aspects of the invention;

FIG. 13 is a schematic cross-section of aspects of the invention;

FIG. 14A is a schematic cross-section of aspects of the invention showing a shear beam support with two inextensible layers;

FIG. 14B is a schematic cross-section of aspects of the invention showing a shear beam support with one upper inextensible layer;

FIG. 14C is a schematic cross-section of aspects of the invention showing a shear beam support with one lower inextensible layer;

FIG. 15 shows a schematic of a Wiper Blade a with rubber shear beam replacing plastic or metal support hardware with partial view of wiper arm.

FIG. 16 is an image of an extrusion die without microstructures.

FIG. 17 is a photograph of section of wiper extrusion die with micro surface.

FIG. 18A is an illustration of a conventional design than ca=n be improved with microstructures.

FIG. 18B is an illustration of a novel design.

FIG. 19 is a photograph of a section of the extruded wiper blade.

FIG. 20 is a photograph of wiper assemblies made with the novel extruded wiper blade.

While each of the drawing figures depicts a particular embodiment for purposes of depicting a clear example, other embodiments may omit, add to, reorder, and/or modify any of the elements shown in the drawing figures. For purposes of depicting clear examples, one or more figures may be described with reference to one or more other figures, but using the particular arrangement depicted in the one or more other figures is not required in other embodiments. The drawings and schematic representations are intended to support the understanding of the invention. These may not be to scale and are not intended to limit the invention to any particular layout, connectivity, or architectural implementation. Correspondence between drawing elements and described components is provided for illustrative purposes and should not be interpreted to limit the claim scope.

### DETAILED DESCRIPTION OF THE INVENTION

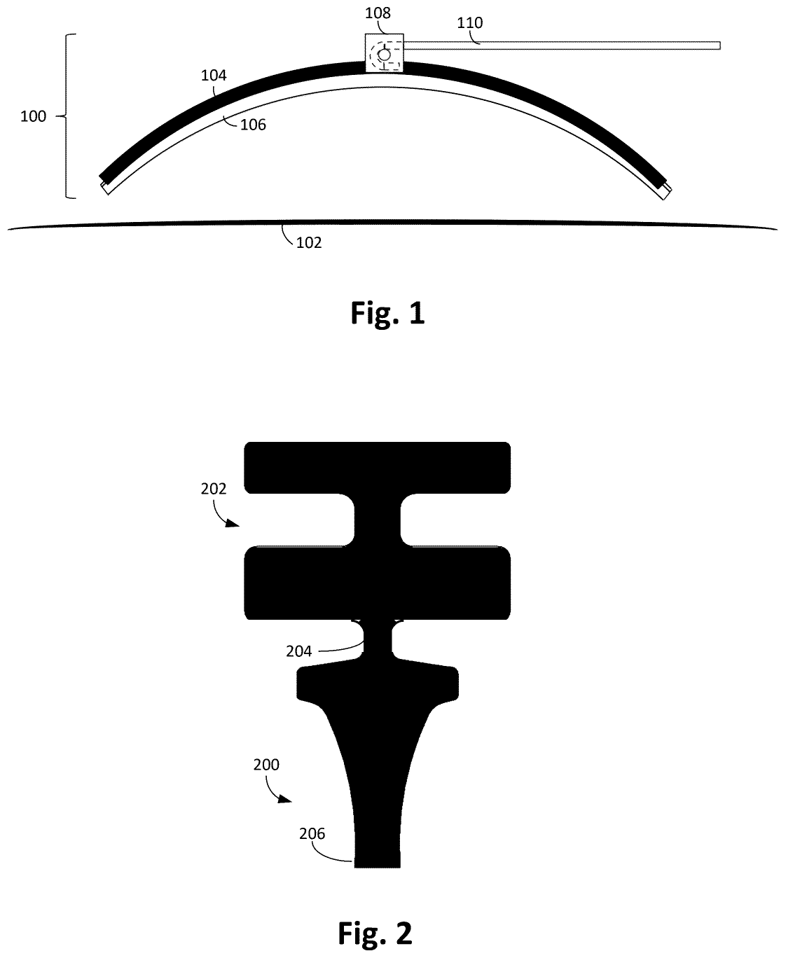

In general, the terms and phrases used herein have their art-recognized meaning, which can be found by reference to standard texts, journal references and contexts known to those skilled in the art. Referring to FIG. 1 a wiper blade assembly 100 which may be pressed against a window 102 to wipe clean. The wiper blade has components consisting of a support structure 104, a wiper strip 106 and a connector 108. The connector can join to the wiper arm 110. The support structure can be adapted to apply uniform or nearly uniform pressure of the wiper blade to the surface 102 and can orient the wiper strip against the surface, such as the window, and may be made of one or more plastic or metal pieces and may incorporate springs, grooves, or slots to mount the wiper strip.

A wiper strip cross-section profile is shown in FIG. 2 and incorporates a wiper strip wiping tip 200, support attachment grooves 202, and a flexible wiping strip attachment 204. The wiper strip wiping tip can be triangular in cross-section and can have a terminal end 206 or heel that can include two sharp corners. This edge can be formed by cutting to a shape in an additional manufacturing step regardless of whether the wiping strip is manufactured by an extrusion process or a molding process. The flexible wiping strip attachment may be elongated and may include flat, angled or wing-shaped bumpers. The wiper strip can be made from one or more resilient rubbery materials.

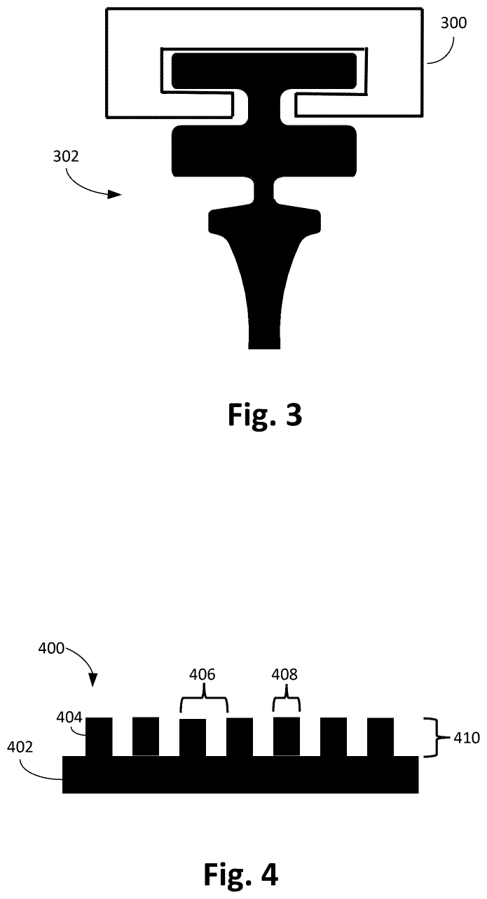

A schematic of a cross-section profile of the support structure 300 is shown in FIG. 3 along with the wiping strip 302. The support structure 300 can be made of metal or plastic can have a lower coefficient of thermal expansion and can flex differently from the wiping strip 302. The grooves of the wiping strip can slide freely in the support structure to avoid wrinkling, buckling or uneven pressure against the surface (e.g., window) as movement occurs across the curved surface and as temperatures may change from freezing cold in winter to hot summer sun.

Microstructure surface terminology is shown in FIG. 4, a micro surface 400 consists of a substrate 402, made of any material, with individual microfeatures 404 rising above or penetrating the substrate. One microfeature may be separated from another microfeature by a pitch 406 distance and have a cross-section width 408 and height or depth 410.

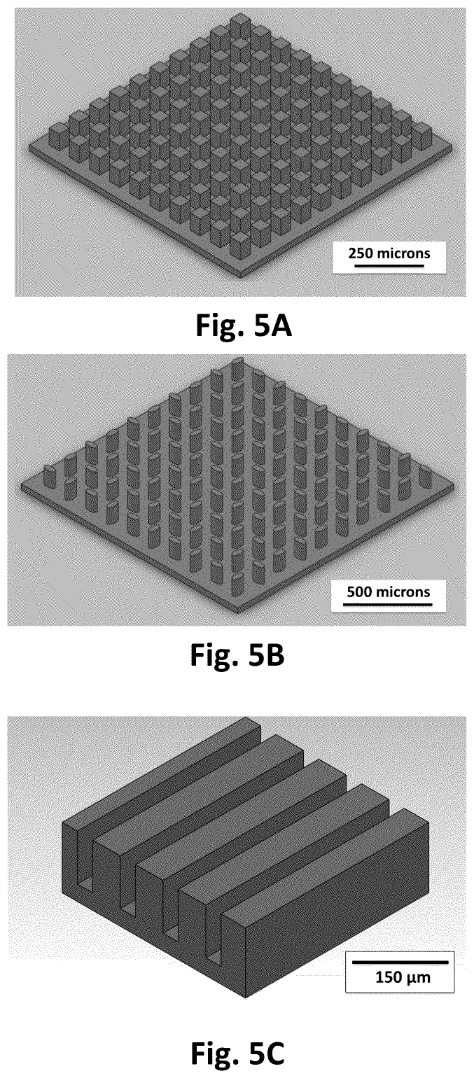

FIGS. 5A through 5C show that micro features on a micro surface may have different cross-section shapes. FIG. 5A shows square cross-section pillars; FIG. 5B shows oval cross-section pillars; and FIG. 5C shows continuous ribs. Pillars are three dimensional shapes while ribs are two dimensional shapes. The microstructures can be selected from a group consisting of two-dimensional cross-sections: continuous ribs, discontinuous ribs, ribs with a cross-section that is rectangular, square, triangular, rounded hump, jagged, overhang or T-shaped. The microstructures can be selected from the group consisting of three-dimensional features: pillars, voids, steps, ridges, curved regions, recessed regions, columns, cross-section shapes comprising circles, ellipses, triangles, squares, rectangles, polygons, stars, hexagons, letters, numbers, symbols, and any combination of these.

The wiping strip can be made of one or more resilient rubbery materials and can include rubber (including natural rubber, styrene-butadiene, polybutadiene, neoprene, ethylene-propylene, butyl, nitrile, silicones), acrylic, nylon, modified polycarbonate, modified polyester, polyethylene, polypropylene, polystyrene, polyvinyl chloride, polyolefin, thermoset polyurethanes, thermoplastic polyurethanes, TPE, TPV and other flexible polymers known to those of skill in the art.

The rubber materials may be formulated to include carbon black, silica or clay fillers, plasticizers, oils, antioxidants, anti-ozone agents, waxes, process aids, cross-linking materials and other formulation ingredients known to those of skill in the art.

The wiping strip may be coated with particles to render the surface matte in appearance and coating with materials such as thermoplastic polyurethane, fluoropolymers, and silicones to change noise, friction and wear properties.

The wiper blade can be adapted for cleaning vehicle windows and structural glass where the wiper blade can include microstructures included with an elongated, rubber-elastic wiper strip provided with respective longitudinal grooves on corresponding opposite long sides for securing to a mounting structure and with a wiper surface with an array of longitudinal micro ribs for contact with a surface such as a window wherein each micro rib can be substantially rectangular in cross-section; an elongated spring-elastic mounting structure having corresponding slots and rails to engage the longitudinal grooves of the wiper strip; and a connection device for a wiper arm or handle connected to the middle portion of the mounting structure.

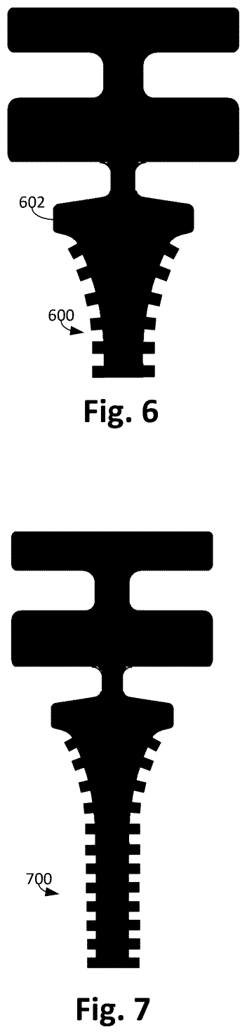

Referring to FIG. 6 a cross section profile of a wiper strip with a wiping tip with a micro surface 600 on each side of the wiping tip 602 is shown. Multiple microfeatures can replace the single cut corner at the end of the wiping tip. The microfeatures on the micro surface can be made manufactured by extrusion or molding processes. The outer portion of the microfeature that presses against the window can be substantially flat and exerts a uniform pressure both across the surface of the individual features and across the multitude of microfeatures contacting the surface (e.g., window or glass). The height, width and pitch of individual micro features may vary. The design may be changed to optimize the pressure profile to improve wiping, to improve resistance to wind at high speeds, to decrease noise and to optimize durability. The two sides of the wiping strip wiping tip that alternately contact the window as the wiping motion occurs in one direction and then the reverse direction and on each side of the wiper surface may have between 2 and 75 micro ribs on each side; the height of the longitudinal micro ribs may be between 20 microns and 1,000 microns; and the width of the longitudinal micro ribs may be between 20 microns and 1,000 microns. If the micro ribs are too large, then they won't fit on the wiper strip without it becoming bulky and too expensive. If the micro ribs are too small, they may not wipe cleanly in high rain conditions and durability may be too little.

In one manufactured example, a wiper strip of the style shown in FIG. 6 was made with 12 micro ribs on each side of the wiping tip. The ribs can be 130 microns wide, 115 microns tall, and has a pitch of 275 microns which gives a spacing of 145 microns between microfeatures. The wiper blade had durability increased 4 times in a laboratory test. The wiper was silent in dry and damp noise testing and quieter than the standard wiper strip.

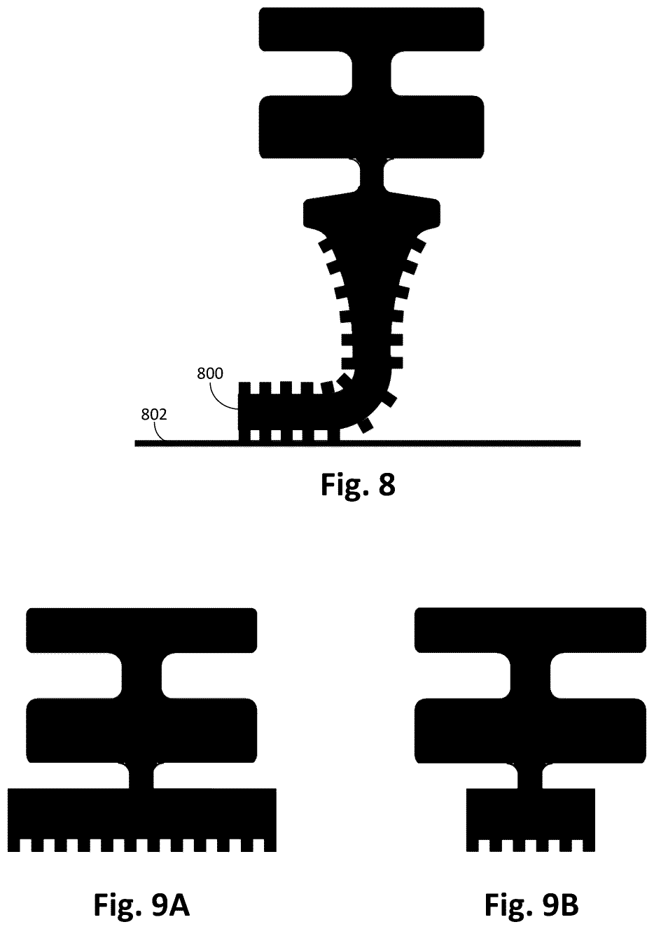

FIG. 7 shows another embodiment of the invention where the wiping tip 700 is elongated. FIG. 8 illustrates the tip 800 bending when pressed against a surface 802. By adjusting tip length, width, material stiffness and design of the micro pattern the uniformity of pressure and the orientation of the wiper strip against the surface may be optimized.

FIGS. 9A and 9B show embodiments where the triangular wiping tip with two sides alternately in contact is replaced with a single-sided flat wiping tip 900. With a single-sided flat wiping tip, the single surface can stay in continuous contact with the surface as the wiper alternates the direction of the wiping. The flip from one side to the other of the wiping tip is eliminated. The single-sided wiping tip can be wider as shown in FIG. 9A or narrower as shown in FIG. 9B.

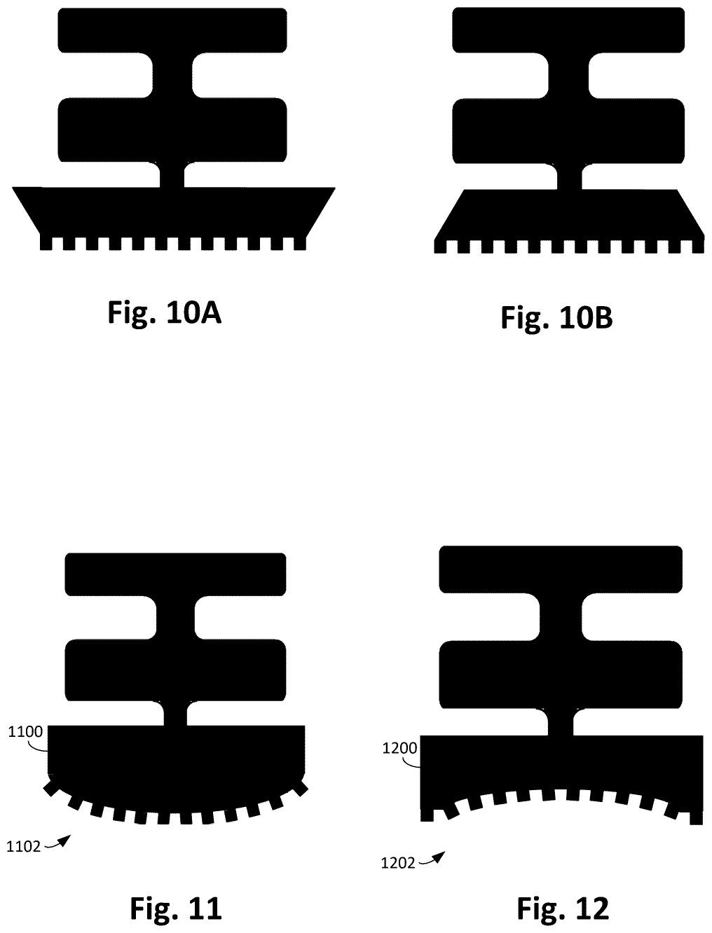

Referring to FIGS. 10A and 10B, the tip can include edges angled outward as shown in FIG. 10A or angled inward as shown in FIG. 10B. The angle and shape of the edges may be adjusted to deflect water or wind and to optimize the pressure profile against the glass.

FIG. 11 shows that the single-sided wiping tip 1100 may have a convex profile 1102.

Referring to FIG. 12, the wiping tip 1200 may have a concave profile 1202.

The single sided wiping tips shown in FIGS. 9 to 12 can be connected to the mounting grooves through a flexible wiping strip attachment. The allows a range of motion for the wiping tip to tip and move to one side or the other during the wiping cycle across the window. Bumpers or wings may be added, and length and width of the flexible attachment may be changed to optimize performance of the single sided wiping tip.

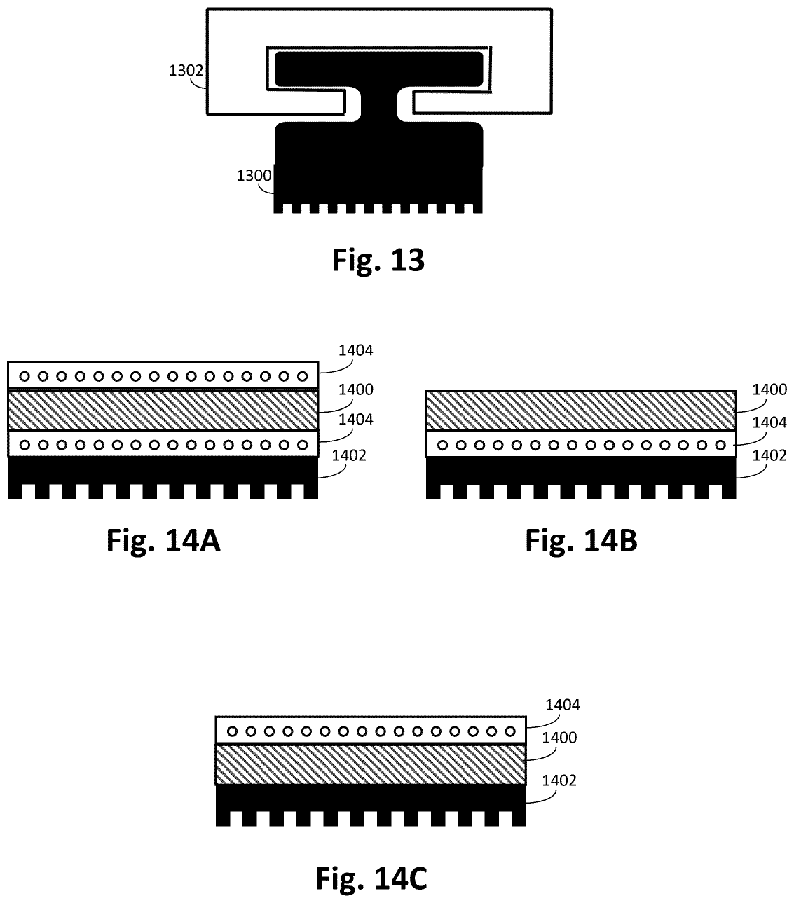

FIG. 13 shows another embodiment of the invention where a single-sided wiping tip 1300, either flat, concave or convex, may be placed directly in contact with a support member 1302 without use of a flexible wiping strip attachment. The range of motion for the wiping tip to tip and move to one side or the other during the wiping cycle across the surface can be determined by the design, stiffness and flexibility of the metal or plastic support member.

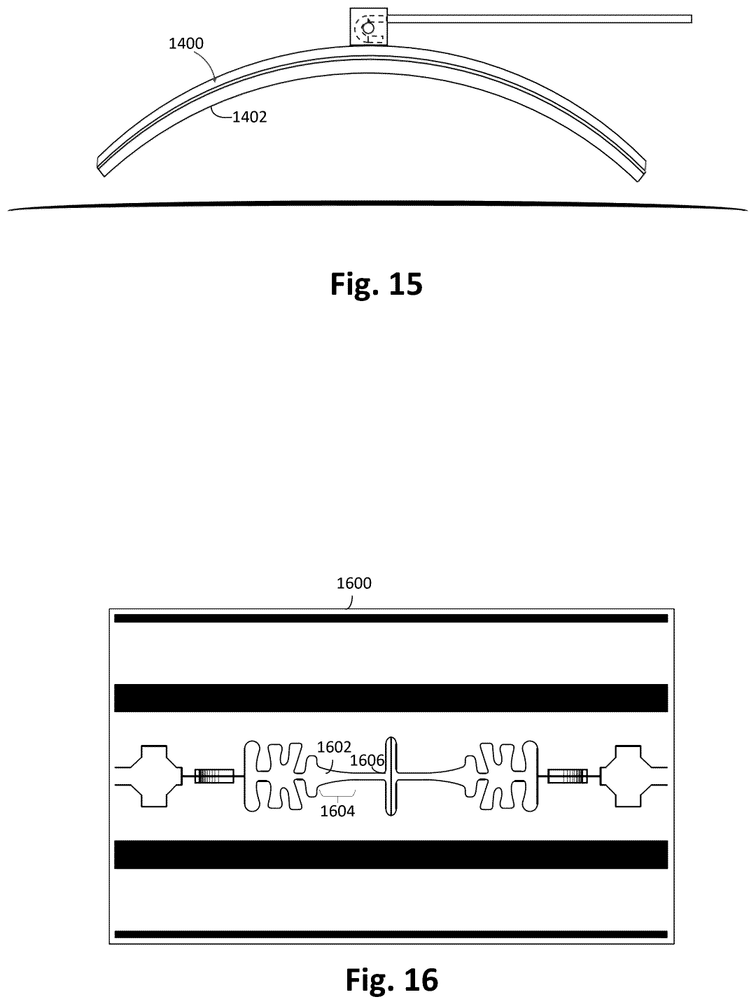

FIGS. 14A through 15 illustrate other embodiments of the invention in which the plastic or metal support structure is replaced by a rubber shear beam 1400 integrated with the wiping strip 1402 that can be a single sided wiping tip. In this embodiment, the rubber shear beam provides the mechanism to provide uniform contact pressure of the wiping tip against the window. Since the rubber shear beam and the rubber wiping strip has similar coefficients of expansion the need for a sliding groove mount is eliminated. Integration of the support and wiping strip provides simplification of the design, and manufacturing, reduces the cost of assembling the components, and enables reducing the weight and height of the wiper blade. For the shear beam to function correctly, a low stiffness rubber shear layer 1400 must be between inextensible layers 1404. The inextensible layers can be two rubber coating textile layers as shown in FIG. 14A. For applications with low contact pressure, the shear beam effect may be achieved with a single inextensible layer and by using rubber layers of different stiffness. FIGS. 14B and 14C show other embodiments.

The inelastic textile layers, shown in FIGS. 14A, 14B, and 14C, may be made of an electrically conductive material such as alloys of steel, brass coated steel, copper or brass metal that may serve as a heating element. The heating element can be used to melt ice.

Wiper blades according to the embodiments shown in FIGS. 1 and 3, without microstructures, and FIG. 6, with microstructures, were fabricated and tested. The wiper blades were manufactured by extrusion using a conventional side-to-side wiper design and a conventional manufacturing process wherein two wiper profiles were simultaneously processed and subsequently slit to produce a cut end as illustrated by element 206 in FIG. 1.

FIG. 16 illustrates a computer-aided design (CAD) image of an example of an extrusion die 1600 profile without microstructure. The opening 1602 is defined in the die allowing material to be extruded through the die. In one embodiment. The die, in the embodiment that include microstructures, can include the microstructures in an area 1604. In one embodiment, the microstructures can extend to the tip 1606.

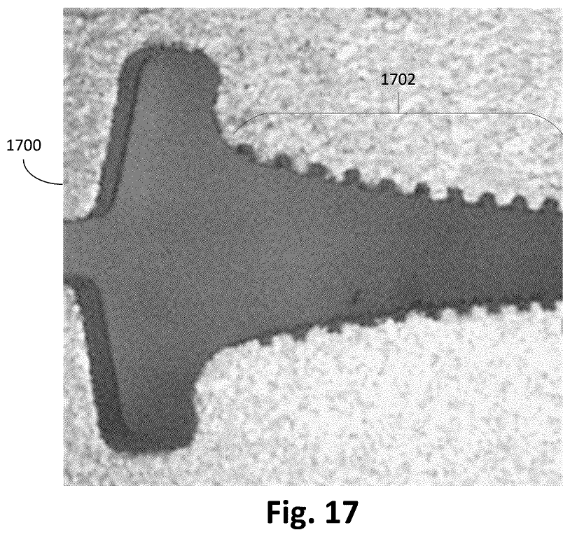

FIG. 17 depicts a photographic representation of a section of the extrusion die 1700 showing the microstructure pattern 1702 cut into the extrusion die. The photograph represents one embodiment where the microstructure features are characterized by a width of 130 microns, a center-to-center pitch of 275 microns, and a depth of 115 microns, wherein the microstructures can extended along the entire length of the blade 600 shown in FIG. 6 to the cut tip.

In one embodiment, the microstructure die of the current invention enables the placement of microstructures on a wiper blade through its specialized design and manufacturing capabilities that overcome traditional extrusion limitations. The die can incorporate precisely machined microstructure patterns cut directly into the extrusion die surface, as shown in FIG. 17, which allows for the simultaneous formation of microfeatures during the extrusion process rather than requiring separate post-processing steps. The die's physical properties include the ability to maintain dimensional accuracy of microfeatures with widths as small as 130 microns and depths of 115 microns while operating under the high pressures and temperatures required for rubber extrusion. The die material and surface finish may be engineered to provide appropriate flow characteristics that allow the rubber material to completely fill the microstructure cavities without air entrapment or incomplete formation. The thermal properties of the die enable it to maintain consistent temperatures across the microstructure pattern, ensuring uniform heating of the rubber and other polymers material as it flows through the die to achieve complete curing and proper microfeature formation. The die's design addresses traditional problems associated with extruding microstructures by providing controlled flow paths that prevent material bridging across microfeature cavities and enable the rubber to conform to the precise microstructure geometry. The durability of the die surface coating or treatment may resist wear from the abrasive rubber compounds and fillers, maintaining microstructure definition over extended production runs. This integrated approach eliminates the need for secondary operations such as coating applications, adhesive bonding, or chemical treatments that were previously required to add microfeatures to wiper blades, thereby reducing manufacturing complexity and cost while ensuring that the microstructures are integrally formed as part of the base rubber material rather than applied as separate surface treatments that may wear away over time.

The structure was tested by extruding and fabricated wiper blades into wiper assemblies and testing the assemblies. In a wind shield wiper wear test on a glass surface, the blade with added micro surface ran four times longer than the smooth control blade when the test was stopped. Qualitative noise testing showed that the blade with micro surface was quieter than the smooth control blade and didn't exhibit stick-slip behavior.

Finite element modeling was used to calculate stresses comparing a conventional wiper blade design and a design of the type shown in FIG. 9 under the same overall load which corresponds to the load on a typical wiper arm (110 of FIG. 1). Finite element modeling is a computational method that divides complex structures into smaller, simpler elements to analyze stress, strain, and deformation behavior under applied loads by solving mathematical equations for each element and combining the results to predict overall structural performance.

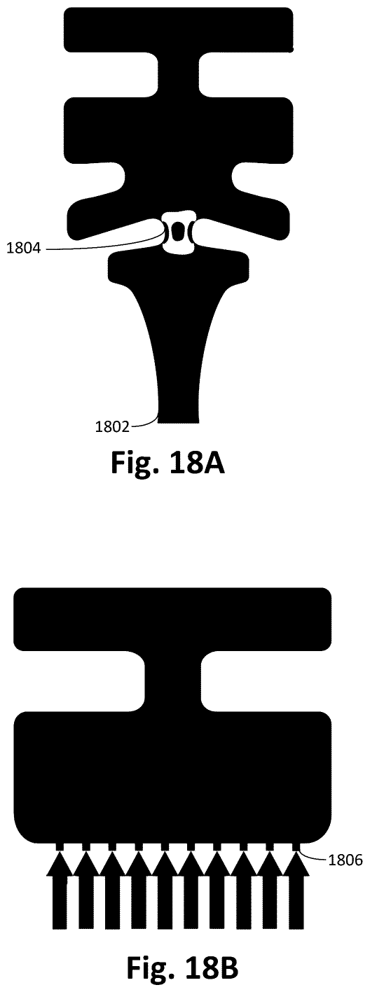

FIGS. 18A and 18B show the results of the finite element analysis of stresses occurring in the illustrated wiper blade designs. The conventional design shown in FIG. 18A shows a maximum von Mises stress at the wiping edge 1802 of 1.535 MPa (206 in FIG. 2) and a maximum von Mises stress of 0.7 MPa in the flex zone 1804 (204 in FIG. 2).

The wiper blade design of the type described in FIG. 9 is shown on FIG. 18B. In this embodiment and design, the maximum von Mises stress at the wiping edge 1806 is 0.028 MPa and the flex zone is eliminated. The maximum stress on a wiping edge is reduced about 55 times with the design of 18B. Higher stress is correlated with higher rates of wear, abrasion and cutting. Thus, the current invention provides lower stress is predicted to have longer wear life and be more resistant to wear, abrasion and cutting.

Von Mises stress is a scalar stress value used in engineering analysis that combines the effects of all stress components (tension, compression, and shear) acting on a material into a single equivalent stress measure. This equivalent stress value may be compared directly to a material's yield strength to predict whether the material will fail or deform plastically under the applied loading conditions. The von Mises stress criterion is used in finite element analysis to evaluate the structural integrity of components under complex loading scenarios.

In another testing scenario, a blade of the design shown in FIG. 11 were extruded and fabricated into wiper assemblies. The micro surface on the extruded blade had 10 parallel micro features of height of 150 microns, center to center pitch of 500 microns and width of 150 microns.

FIG. 19 is a photograph of a section of the extruded wiper blade of the type described in FIG. 11.

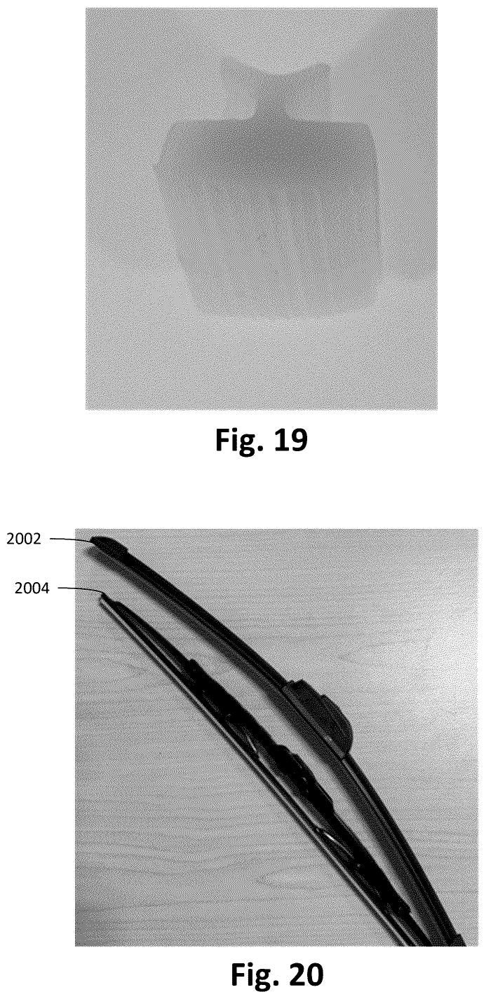

FIG. 20 shows wiper assemblies made with the blade prototypes of the design shown in FIG. 11. One wiper assembly 2002 has a beam type support and the other wiper assembly 2004 has a conventional multi-piece metal support structure.

The beam type support 2002 shown in wiper assemblies in FIG. 20 may comprise a single continuous structural element that extends along the length of the wiper blade to distribute contact pressure uniformly across the wiping surface. This beam type support may be constructed from a flexible material such as spring steel or a composite material that allows the wiper blade to conform to curved windshield surfaces while maintaining consistent pressure distribution. The beam type support may incorporate a streamlined profile that reduces wind resistance and may include attachment points for connecting to the wiper arm mechanism.

The multi-piece metal support structure 2004 may include multiple articulated segments connected by pivot joints or hinges that allow independent movement of different sections of the wiper blade. This multi-piece design may comprise a primary support frame with secondary support elements, such as pressure distributors or yokes, that help maintain contact between the wiper strip and the windshield surface across varying curvatures. The multi-piece metal support structure may include multiple connection points where individual segments are joined, and these connections may allow for rotational or pivoting movement to accommodate the contours of the windshield. The metal components of this support structure may be manufactured from materials such as galvanized steel, stainless steel, or aluminum alloy to provide durability and corrosion resistance.

The beam type support may offer advantages in terms of reduced complexity, fewer moving parts, and potentially lower manufacturing costs, while the conventional multi-piece metal support structure may provide enhanced conformability to complex windshield curvatures through its articulated design. Both support structures may be designed to work effectively with the microstructured wiper strip to achieve improved wiping performance and durability.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A wiper blade for cleaning a vehicle surface, comprising:
a wiper strip having a wiper surface with an array of longitudinal microfeatures applied during an extrusion process;
a portion of the microfeatures in the array of longitudinal microfeatures adapted to contact the vehicle surface;
an elongated spring-elastic mounting structure having slots and rails configured to engage the wiper strip; and
a connection device for a wiper arm connected to the elongated spring-elastic mounting structure, wherein the array of microfeatures is configured to reduce sliding noise on a dry or damp surface below 50 dB.

2. The wiper blade of claim 1 including a plurality of wiping edges included in the wiper blade.

3. The wiper blade of claim 1 wherein each microfeature has a height between 20 microns and 1,000 microns and a width between 20 microns and 1,000 microns.

4. The wiper blade of claim 1, wherein the wiper surface include a first side and a second side wherein the first side and the second side alternately contact the vehicle surface as a reciprocating wiping motion occurs.

5. The wiper blade of claim 4, wherein the first side of the wiper surface includes a number of longitudinal microfeatures in the array between 2 and 75.

6. The wiper blade of claim 1, wherein the wiper surface has a single side that contacts the vehicle surface as a reciprocating wiping motion occurs.

7. The wiper blade of claim 5, wherein the single side that contacts the vehicle surface has a cross-section surface shape that is flat, convex, or concave.

8. The wiper blade of claim 6, wherein on the single side of the wiper surface a number of longitudinal microfeatures is in an array between 2 and 150.

9. The wiper blade of claim 6, wherein the array of microfeatures and the single contact surface are configured to reduce flop noise below 50 dB as the wiping motion changes from one direction to a reverse direction.

10. The wiper blade of claim 1, wherein the wiper strip is made from a material selected from the group consisting of natural rubber, styrene-butadiene, polybutadiene, neoprene, ethylene-propylene, butyl, nitrile, silicones, thermoplastic polyurethanes, and combinations thereof.

11. The wiper blade of claim 1, wherein the wiper strip material includes fillers selected from the group consisting of carbon black, silica, and clay fillers.

12. A wiper blade manufactured using an extrusion die, the wiper blade comprising:
a wiper strip having a wiping tip with microstructures formed integrally during extrusion, wherein the microstructures comprise longitudinal micro ribs having a substantially rectangular cross-section; and
respective longitudinal grooves on opposite long sides of the wiper strip for securing to a mounting structure, wherein the microstructures are placed on the wiping tip to provide multiple wiping edges that contact a vehicle surface.

13. The wiper blade of claim 12 wherein the microstructures include a width of 130 microns, a height of 115 microns, and a center-to-center pitch of 275 microns.

14. The wiper blade of claim 12, wherein the microstructures extend along an entire length of the wiping tip to a cut end of the wiper strip.

15. The wiper blade of claim 12, wherein the extrusion die comprises machined microstructure patterns cut directly into an extrusion die surface to enable simultaneous formation of the microstructures on the wiper blade during the extrusion process.

16. The wiper blade of claim 12, wherein the wiper strip exhibits increased durability of at least four times longer wear life compared to a wiper blade without microstructures when tested under identical conditions.

17. A wiper blade assembly for cleaning a vehicle surface, comprising:
a wiper blade having a wiper strip with a wiper surface comprising an array of longitudinal microfeatures integrated with the wiper blade during the extrusion process;
a support structure configured to apply uniform pressure of the wiper blade to the vehicle surface; and
a connector configured to join to a wiper arm, wherein the wiper surface has a side that contacts the vehicle surface as wiping motion occurs in both directions, and the single side has between 2 and 150 longitudinal microfeatures.

18. The wiper blade assembly of claim 17, wherein the microfeatures have a height between 20 microns and 1,000 microns and a width between 20 microns and 1,000 microns.

19. The wiper blade assembly of claim 17, wherein the side that contacts the vehicle surface has a cross-section surface shape that is flat, convex, or concave with rounded edges.

20. The wiper blade of claim 17 wherein the side of a first side and the wiper blade include a second side wherein the first side and the second side include microstructures and wherein the first side and the second side alternately contact the vehicle surface as a reciprocating wiping motion occurs.

21. The wiper blade assembly of claim 17, wherein the support structure comprises a beam type support that extends along a length of the wiper blade to distribute contact pressure uniformly across the wiper surface.

22. A wiper blade for cleaning a vehicle surface, comprising:
a wiper strip;
a wiper surface included in the super strip; and,
an array of longitudinal microfeatures applied during an extrusion process to the wiper surface wherein a portion of the microfeatures in the array of longitudinal microfeatures is adapted to contact the vehicle surface.
